(19) United States
(12) Patent Application Publication
(10) Pub. No.: US 2002/0156543 A1
(43) Pub. Date: Oct. 24, 2002

(54) Alternative resource model

(75) Inventors: Shou-Chung Chen, Kaohsiung (TW); Chi-Hui Yeh, Hsinchu (TW); Si-Ping Cheng, Hsinchu (TW); Liang-Yei Chen, Taipei Hsien (TW)

Correspondence Address: CHARLES C.H. WU & ASSOCIATES, Suite 710, 7700 IRVINE CENTER DRIVE, Irvine, CA, 92618-3043, US

(73) Assignee: UNITED MICROELECTRONICS CORP.

(21) Appl. No.: 09/858,983

(22) Filed: May 16, 2001

(30) Foreign Application Priority Data
Apr. 24, 2001 (TW) 90109739

(51) Int. Cl. G05B 13/02

(52) U.S. Cl. 700/31

(57) ABSTRACT

An alternative resource model. The alternative resource is suitable for a first resource and a second resource. A first process and a second process are performed in the first resource and the second process and a third process are performed in the second resource. A pseudo resource is provided and a capacity of the pseudo resource is equal to a sum of a capacity of the first resource and a capacity of the second resource. The first process is allocated to consume the capacity of the first resource and the capacity of the pseudo resource. The third process is allocated to consume the capacity of the second resource and the capacity of the pseudo resource. The second process is allocated to consume the remaining capacity of the pseudo resource.

### CROSS-REFERENCE TO RELATED APPLICATION

This application claims the priority benefit of Taiwan application serial no. 90109739, filed Apr. 24, 2001.

### BACKGROUND OF THE INVENTION

1. Field of Invention

The present invention relates to a producing schedule of a manufactory. More particularly, the present invention relates to an alternative resource model in a producing schedule of a manufactory.

2. Description of Related Art

Typically, producing schedule is defined as a methodical producing procedure organized from the product list and the plan schedule of the necessary capacity consumption used in the producing plan period according to the customized routings, process operations and available resources.

The process operation is claimed to be a capacity consumer of the resources. However, in the semiconductor manufactory, more than one producing process can be performed in a single resource and a single producing process can be performed by different resources. Besides, the processing times for various processes in the same resource are different from each other. Hence, it is hard to estimate the overall capacity of the resources.

FIGS. 1 through 2 are schematic, diagrams of the conventional ways to solve the problem for estimating capacity of various processes performed in the same resource.

As shown in FIG. 1, when a process A 100 and a process B 102 are performed in a resource R1 and the process B 102 and a process C 104 are performed in a resource R2, the conventional way to solve the problem of estimating the overall capacity is to regard the resource R₁ and the resource R₂ as a group resource RG 112. Therefore, the overall capacity of the group resource RG 112 is the sum of the capacity of the resource R₁ and the capacity of the resource R₂. However, when the work order for the products produced by using the process C 104 is larger than the capacity of the resource R₂ and is smaller than the capacity of the group resource RG 112, the planning system for assigning the work order to the resources will keep on receiving work orders. In fact, since the process C 104 only can be performed in the resource R₂ and the work order is really larger than what the resource C can deal with, the manufactory cannot produce the products on time to satisfy the requirements of the customers. Simultaneously, when the work order for the products produced by using the process A 100 is larger than the capacity of the resource R₁ and is smaller than the capacity of the group resource RG 112, the planning system for assigning the work order to the resources will keep on receiving work orders. Therefore, the manufactory cannot produce the products on time to satisfy the requirements of the customers because the process A 100 only can be performed in the resource R₁ and the work order is really larger than what the resource A can deal with.

As shown in FIG. 2, another conventional method for solving the problem of estimating the overall capacity is to regard the resource R₁ and the resource R₂ as different resources labeled as resource R₁ 212 and resource R₂ 214. However, by using this method, the planning system cannot figure out whether the work order for the product produced by using the process B 202 should be received since the process B 202 can be performed in both the resource R₁ 212 and the resource R₂ 214. If the work order for the product produced by using the process B 202 is only assigned to consume the capacity of the resource R₁ 212, the subsequent work order for the product produced by process A 200 only can use the remaining capacity of the resource R₁ 212. Sometimes, the remaining capacity of the resource R₁ 212 also cannot satisfy the requirement for process A 200. Simultaneously, if the work order for the product produced by using the process B 202 is only assigned to consume the capacity of the resource R₂ 214, the subsequent work order for the product produced by process A 200 only can use the remaining capacity of the resource R₂ 214. Sometimes, the remaining capacity of the resource R₂ 214 also cannot satisfy the requirement for process C 204. Therefore, this method cannot efficiently utilize the overall capacity of the resource R₁ 212 and the resource R₂ 214 to reach the requirement of the customers.

### SUMMARY OF THE INVENTION

The invention provides an alternative resource model. The alternative resource is suitable for a first resource and a second resource. A first process and a second process are performed in the first resource and the second process and a third process are performed in the second resource. A pseudo resource is provided and a capacity of the pseudo resource is equal to a sum of a capacity of the first resource and a capacity of the second resource. The first process is allocated to consume the capacity of the first resource and the capacity of the pseudo resource. The third process is allocated to consume the capacity of the second resource and the capacity of the pseudo resource. The second process is allocated to consume the remaining capacity of the pseudo resource.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1 through 2 are schematic, diagrams of the conventional ways to solve the problem for estimating capacity of various processes performed in the same resource; and

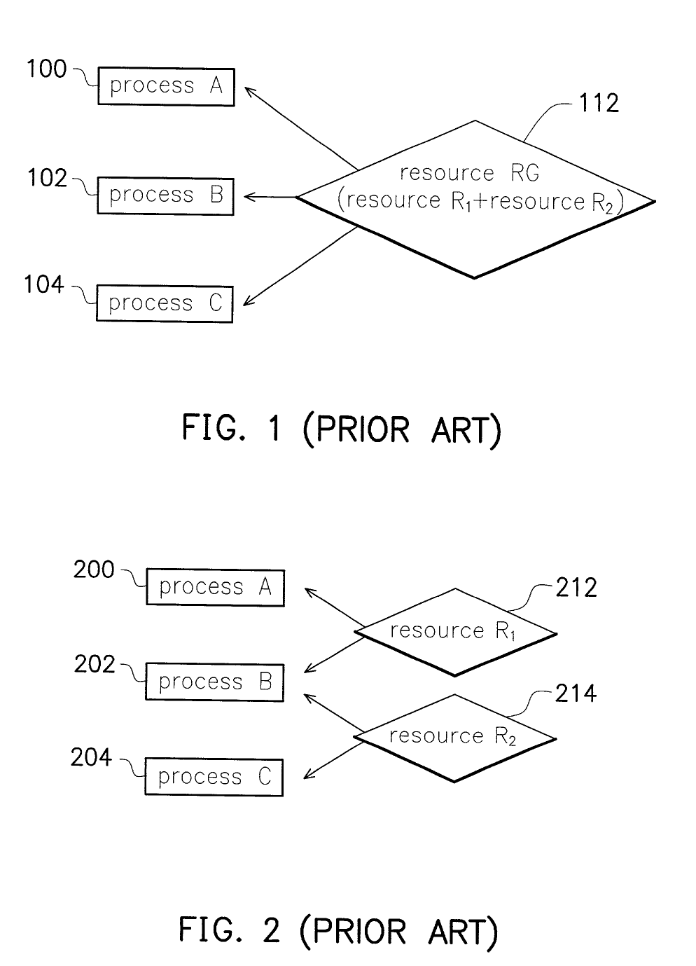

FIG. 3 is schematic, diagram of an alternative resource model for estimating the overall capacity of various processes performed in the same resource in a preferred embodiment according to the invention.

### DESCRIPTION OF THE PREFERRED EMBODIMENTS

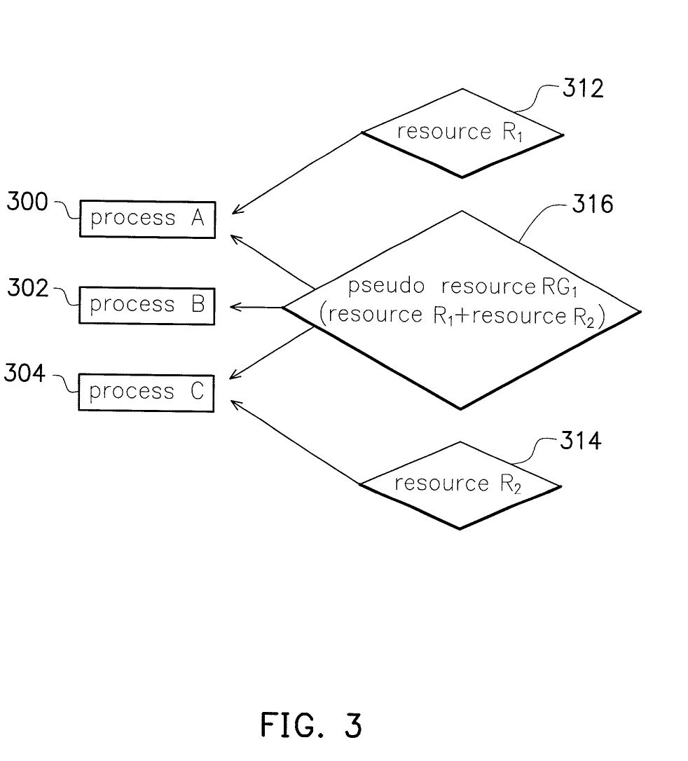

FIG. 3 is schematic, diagram of an alternative resource model for estimating the overall capacity of various processes performed in the same resource in a preferred embodiment according to the invention.

As shown in FIG. 3, a process A 300 and a process B 302 are performed in a resource R₁ 312. The process B 302 and a process C 304 are performed in a resource R₂ 314. The process B can be performed in both the resource R₁ 312 and resource R₂ 314.

A pseudo resource RG, 316 is provided and the capacity of the pseudo resource RG₁ 316 is the sum of the capacity of the resource R₁ 312 and the resource R₂ 314. The process A 300 is allocated to consume portions of the capacity of the resource R₁ 312 and portions of the capacity of the pseudo resource RG₁ 316. Also, the process C 304 is allocated to consume portions of the capacity of the resource R₂ 314 and portions of the capacity of the pseudo resource RG₁ 316. Moreover, the process B 302 is allocated to consume the remaining capacity of the resource R₁ 312 and the resource R₂ 314.

Since the process B 302 can be performed in both the resource R₁ 312 and the resource R₂ 314, allocating the process B 302 to consume the capacity of the pseudo resource RG₁ 316 can lead to the remaining capacity of the resource R₁ 312 and the resource R₂ 314 being efficiently utilized by the process B 302. In a manner of speaking, the requirements work order for the products produced by process B 302 are shared by both the resource R₁ 312 and the resource R₂ 314.

On the other hand, when the process B 302 is allocated to consume the capacity of the pseudo resource 316, the sequent work order requirement for process A 300 can be allocated to the remaining capacity of resource R₁ 312. Simultaneously, the sequent work order requirement for process C 304 can be allocated to the remaining capacity of resource R₂ 314. Therefore, the overall capacity of the resources can be utilized efficiently and the problem of over allocating work order to the resources can be well avoided.

Although allocating three processes to two resources is an example in the preferred embodiment according to the invention, the present invention can be also applied to the situation of allocating more than three processes to more than two resources. The number of the resources are m and the number of the processes is n (m<n). Moreover, the number of the processes which can be performed in various resources are p and the number of the processes which only can be performed in particular resources are q (n=p+q). The i-th process which can be performed in various resources is allocated to a resource group R(i) and the j-th process which only can be performed in particular resources is allocated to a resource S(j). In the Alternative resource model, when an integer i is selected from the range between 1 to p, a pseudo resource RG(i) is provided between every resources in the resource group R(i) and the overall capacity of the pseudo resources RG(i) is equal to the sum of the capacity of the resources R(i). Moreover, the capacity of any resource in the m resources is estimated into at least one pseudo resource. When an integer j is selected from the range between 1 to j and the j-th process is allocated to consume the capacity of resource S(j). The consume capacity is regarded as the consuming the capacity of pseudo resources those the resource S(j) belong to and the i-th process is allocated to consume the remaining capacity of the resource group RG(i). Alternatively, the i-th process can be allocated to consume the capacity of the pseudo resource group RG(i) and then the j-th process is allocated to consume the remaining capacity of the resource S(j) when i is selected from 1 to p and j is selected from 1 to q.

Altogether, the present invention possesses following advantages:

1. In the present invention, a pseudo resource is provided and the capacity of the pseudo resource is equal to the sum of the capacity of the resources. Therefore, the overall capacity of the resources can be well controlled.

2. By using the alternative resource model, the process requirement won't exceed the capacity of the particular resource.

3. By using the alternative resource model, the process can be allocated to consume the present capacity of the resources to meet the customer requirements, efficiently.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An alternative resource model suitable for a first resource and a second resource, wherein a first process and a second process are performed in the first resource and the second process and a third process are performed in the second resource, the model comprising the steps of:
providing a pseudo resource, wherein a capacity of the pseudo resource is equal to a sum of a capacity of the first resource and a capacity of the second resource;
allocating the first process to consume the capacity of the first resource and the capacity of the pseudo resource;
allocating the third process to consume the capacity of the second resource and the capacity of the pseudo resource; and
allocating the second process to consume the remaining capacity of the pseudo resource.

2. An alternative resource model suitable for a first resource and a second resource, wherein a first process and a second process are performed in the first resource and the second process and a third process are performed in the second resource, the model comprising the steps of:
providing a pseudo resource, wherein a capacity of the pseudo resource is equal to a sum of a capacity of the first resource and a capacity of the second resource;
allocating the second process to consume the capacity of the pseudo resource;
allocating the first process to consume the remaining capacity of the first resource; and
allocating the third process to consume the remaining capacity of the second resource.

3. An alternative resource model suitable for m resources, wherein n processes are performed in the m resources, m is less than n, and p processes of the n processes are performed in various resources and q processes of the n processes are performed in particular resources (n=p+q), an i-th process performed in various resources is performed in a resource group R(i) and a j-th process performed in particular resources is performed in a resource S(j), the model comprising the steps of:
selecting i from 1 to p and providing a pseudo resource RG(i) between every resources R(i), wherein a capacity of the pseudo resource RG(i) is equal to the sum of a capacity of the resources R(i), and the capacity of any resources in m resources is estimated into at least one pseudo resource;
selecting j from 1 to q and allocating a j-th process to consume a capacity of the resource S(j), wherein the consuming capacity of the resource S(j) is regarded as a consuming the capacity of pseudo resources those the resource S(j) belong to; and
allocating the i-th process to consume the remaining capacity of the pseudo resources RG(i).

4. An alternative resource model suitable for m resources, wherein n processes are performed in the m resources, m is less than n, and p processes of the n processes are performed in various resources and q processes of the n processes are performed in particular resources (n=p+q), an i-th process performed in various resources is performed in a resource group R(i) and a j-th process performed in particular resources is performed in a resource S(j), the model comprising the steps of:
selecting i from 1 to p and providing a pseudo resource RG(i) between every resources R(i), wherein a capacity of the pseudo resource RG(i) is equal to the sum of a capacity of the resources R(i), and the capacity of any resources in m resources is estimated into at least one pseudo resource;
allocating the i-th process to consume the capacity of the pseudo resources RG(i); and
selecting j from 1 to q and allocating a j-th process to consume the remaining capacity of the resource S(j).
